(19) United States
(12) Patent Application Publication
(10) Pub. No.: US 2009/0271780 A1
(43) Pub. Date: Oct. 29, 2009

(54) AUTOMATIC COMPLETE FIRMWARE UPGRADE

(75) Inventors: Sanjeev B., Hyderabad (IN); Bhagwat MASALKAR, Maharashtra (IN)

Correspondence Address: LOWE HAUPTMAN HAM & BERNER, LLP, 1700 DIAGONAL ROAD, SUITE 300, ALEXANDRIA, VA, 22314, US

(73) Assignee: MOSCHIP SEMICONDUCTOR TECHNOLOGY LIMITED, Hyderabad (IN)

(21) Appl. No.: 12/108,689

(22) Filed: Apr. 24, 2008

(51) Int. Cl. G06F 9/44; G06F 12/06

(52) U.S. Cl. 717/173; 711/171; 711/E12.084

(57) ABSTRACT

A method for automatic firmware upgrade on a target embedded system connected to a TFTP server and a web console is disclosed. The method includes generating a single image from Linux kernel image and file system image and providing single image name as input to web console for firmware upgrade. The web console write upgrade flag and single image name in the kernel configuration and issue a restart command to the embedded system. At boot up time, the start up module checks for firmware upgrade flag set and issue commands for loading the image on target board and boots up with the upgraded image. The firmware upgrade is performed over the network. Further, the embedded system is upgraded with very less user interaction reducing firmware upgrade time and by reducing dependence of experienced/skilled person.

### BACKGROUND

1. Technical Field

The embodiments herein generally relate to embedded systems, and, more particularly, to complete and automatic firmware upgrade on embedded systems via network.

2. Description of the Related Art

Embedded systems generally comprise of embedded operating system (OS) and software applications. Software applications typically run on top of an embedded operating system (for example, Linux). The embedded operating system and software applications are in combination hereafter generically referred to as “firmware”.

Firmware upgrade is necessary in order to improve performance and to meet changing needs. Generally, the system startup programs and firmware are treated as a single file system image which enables to simplify the maintenance and upgrade. Firmware upgrade is done using the following two steps:

1. The operating system image is updated

2. The file system image with application is updated.

Usually, a firmware upgrade process requires user intervention. Upgrading firmware of embedded systems requires individuals performing upgrade to have knowledge of embedded systems and requires performing a number of complicated steps. An upgrade file is downloaded to embedded system by means of a file transfer protocol. The download is performed with a special program (for example, TFTP) and the individual performing download is required to specify, for example, in the form of a network address, location to store data in the embedded system being upgraded.

In addition, there are circumstances where the entire embedded software image needs to be upgraded or replaced to meet application needs and/or business needs and therefore making the upgrade process more complicated for an individual. Also, in many situations, embedded systems are placed in inaccessible location. Furthermore, when upgrading firmware, there is the risk of communication failure during firmware download. Such failure could result in erratic behavior of embedded systems, and may require considerate efforts to repair. These aspects make operation of upgrading firmware of an embedded system difficult and time consuming for an individual.

### SUMMARY

In view of the foregoing, an embodiment herein provides a method for automatic firmware upgrade on a target embedded system connected to a TFTP server and a web console, wherein the embedded system comprises of a volatile and a non-volatile memory, and the non-volatile memory comprises of a startup module, kernel configuration, an existing kernel image, and an existing file system image.

Another embodiment provides a method of automatic firmware upgrade in embedded systems, wherein the method comprises of generating a single image from Linux kernel image and file system image, storing the single image on the TFTP server; writing upgrade flag and single image name information in the kernel configuration on the embedded system; issuing a restart command to the target embedded system; startup module on target embedded system checking for upgrade flag; copying the single image from TFTP server to the volatile memory of the embedded system; erasing the existing kernel image and the existing file system image; copying the single image from the volatile memory to a pre-determined location on the non-volatile memory; resetting the upgrade flag; and issuing command to boot using the single image. In various embodiments, the upgrade includes applications and the embedded system uses one IVT.

In another embodiment disclosed herein, the start up module continues with normal boot up process when single image is not found after pre-determined maximum number of attempts.

In another embodiment, the upgrade flag is set as an environment variable of kernel configuration in a protected memory on the target embedded system and the user resets the upgrade flag using a web-console utility.

In yet another preferred embodiment, the method of writing upgrade flag information comprises of performing of CRC calculation and storing the calculated CRC in a predetermined location.

Moreover, another embodiment provides a method of generating single image by combining kernel image and file system image, includes calculating offset based on kernel image file size by an external utility, and combining the flash file system image with the kernel image using the calculated offset.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram illustrating the environment of the invention;

FIG. 2 is a sequence diagram illustrating the concept of firmware image upgradation sequence;

FIG. 3 illustrates a schematic diagram of the flash contents of the embedded system;

FIG. 4 illustrates a combined firmware upgrade image;

FIG. 5 illustrates a flowchart depicting a method of writing upgrade flag information in the flash, according to embodiments disclosed herein; and

FIG. 6 illustrates a flowchart depicting a method of upgrade sequence from modified boot loader present on board, according to embodiments disclosed herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

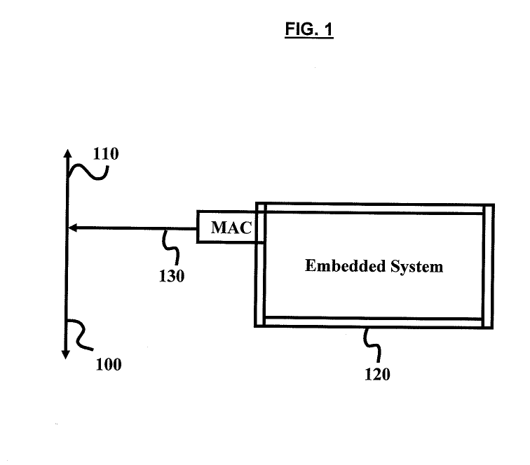

As mentioned, there remains a need for a method for a complete automatic firmware upgrade. The embodiments herein achieve this by providing a method and system for complete automatic firmware upgrade. Referring now to the drawings, and more particularly to FIGS. 1 through 6, where similar reference characters denote corresponding features consistently throughout the figures, there are shown preferred embodiments.

FIG. 1 is a system block diagram showing the environment of the invention. A web console 100, which is connected with the network 110, is a PC running web console utility and TFTP server application. The network 110 comprises of WAN or internet and is connected to the embedded system 120 through LAN 130. Web console 100 is a utility program which is part of the applications running on embedded system 120. The embedded system 120 can also be directly connected to the web console 100 through LAN 130. A first firmware single image is generated using new single-image utility and the image is inputted to the web console 100 which in turn sets an upgrade flag on embedded system 120 for firmware upgrade. On successful storing of new state of the upgrade flag on embedded system 120 the web console 100 issues command to restart the embedded system 120.

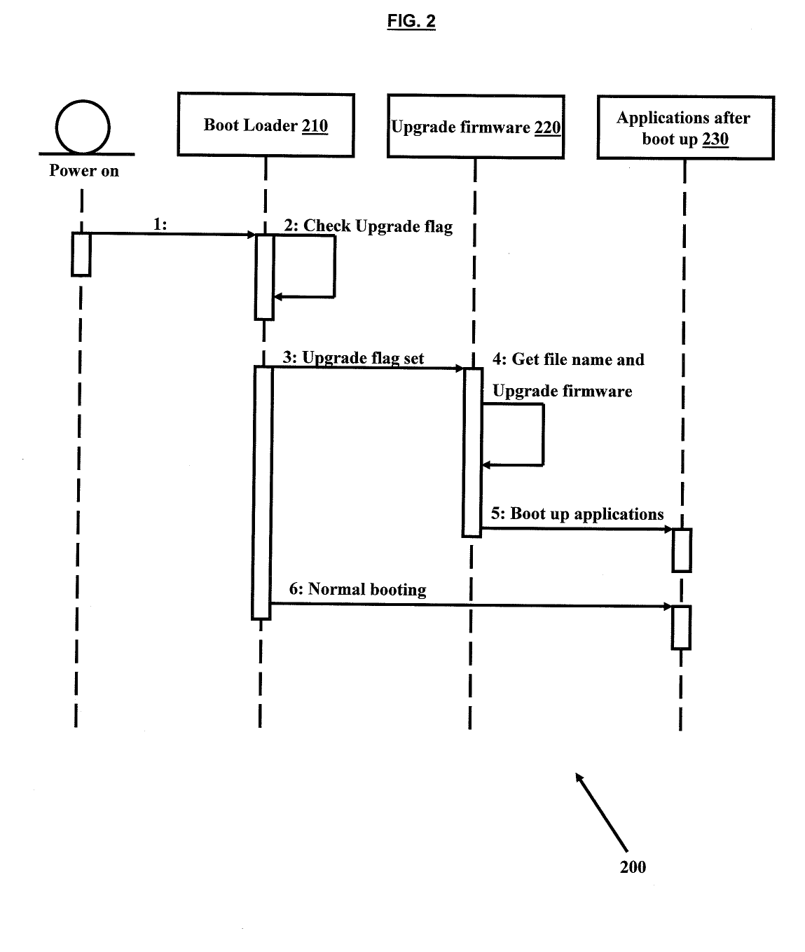

FIG. 2 is a sequence diagram 200 illustrating the concept of firmware image upgradation sequence. The power to the embedded system 120 is switched on and at boot up time, the boot loader 210 verifies whether a firmware upgrade has to be performed. On booting up, the embedded system 120 checks for firmware upgrade flag. If the upgrade flag is set, then the new firmware single image is generated from a single-image utility which takes two images as input and generates a new single image out of these two images. Through web console 110, set command as firmware upgrade and provide the new firmware single image. On reset and while booting, the embedded system 120 has learnt that a firmware upgrade 220 has to be performed with the specified firmware upgrade file and the file is stored in the volatile memory of the embedded system 120 through TFTP protocol. The file is loaded and copied at specified location and then the embedded system 120 issues command to boot up with new updated firmware image 230. If the upgrade flag is not set, then the embedded system 120 boots up normally with available image.

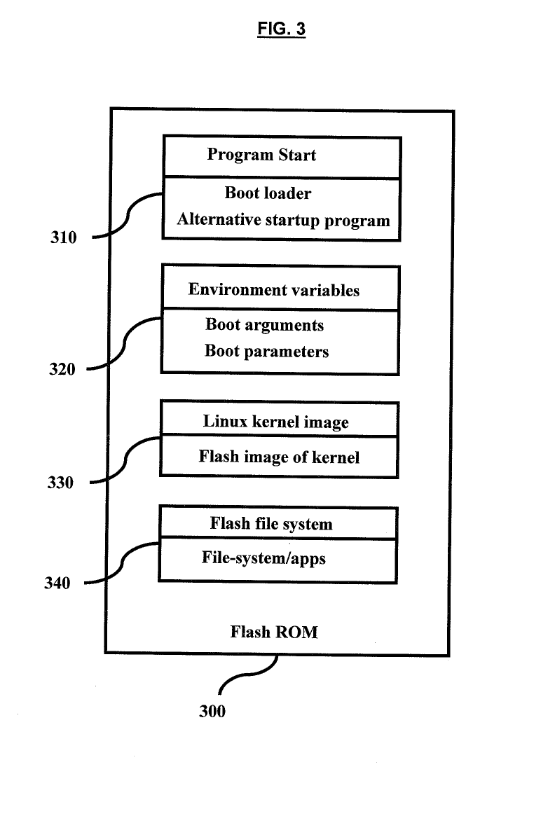

FIG. 3 illustrates the flash ROM contents of embedded system 120. The Flash ROM 300 mainly includes a startup program 310, a kernel configuration 320 and an embedded OS 330, instanced as Linux. The startup program 310 is a special program which does basic low level initialization of embedded system 120 and is responsible for loading embedded OS 330 from non volatile memory (NVM) to random access memory (RAM) for further execution of application programs. Kernel configurations 320 are passed on to embedded OS 330 as boot up arguments and parameters while booting up. The upgrade flag is stored in kernel configurations 320 area which is also referred as environment variable section. Modifications are done in startup program 310 to check the state of upgrade flag on reset. A single image from Linux kernel image and file-system image is generated using single-image utility for firmware upgrade. The flash file system 340 on flash ROM 300 is designed to store the files and the file-system maintains the physical location of the files and provides access to data on a file server for automatic firmware upgradation.

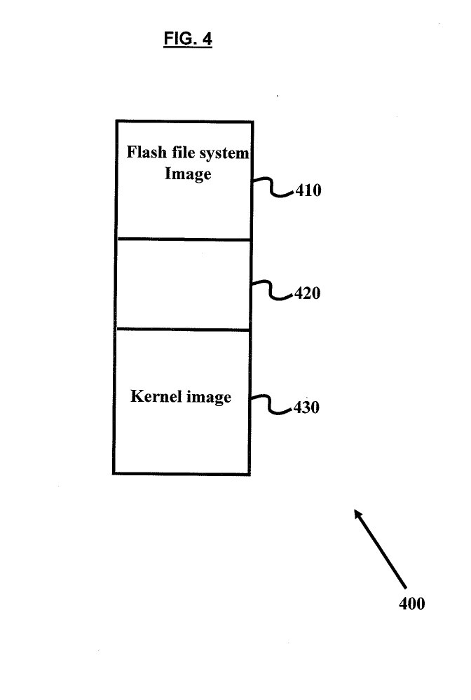

FIG. 4 illustrates a combined firmware upgrade image 400. The flash file system image 410 is combined with an offset or blank space 420 from kernel image 430. The offset or blank space 420 is calculated based on kernel image 430 file size. The offset calculation is done by a new image utility. Kernel image 430 in embedded system 120 takes start address as 0x1C060000 and flash file system image 410 takes start address as 0x1C200000. The difference between the two start address is blank space 420 which varies with kernel image 430 file size.

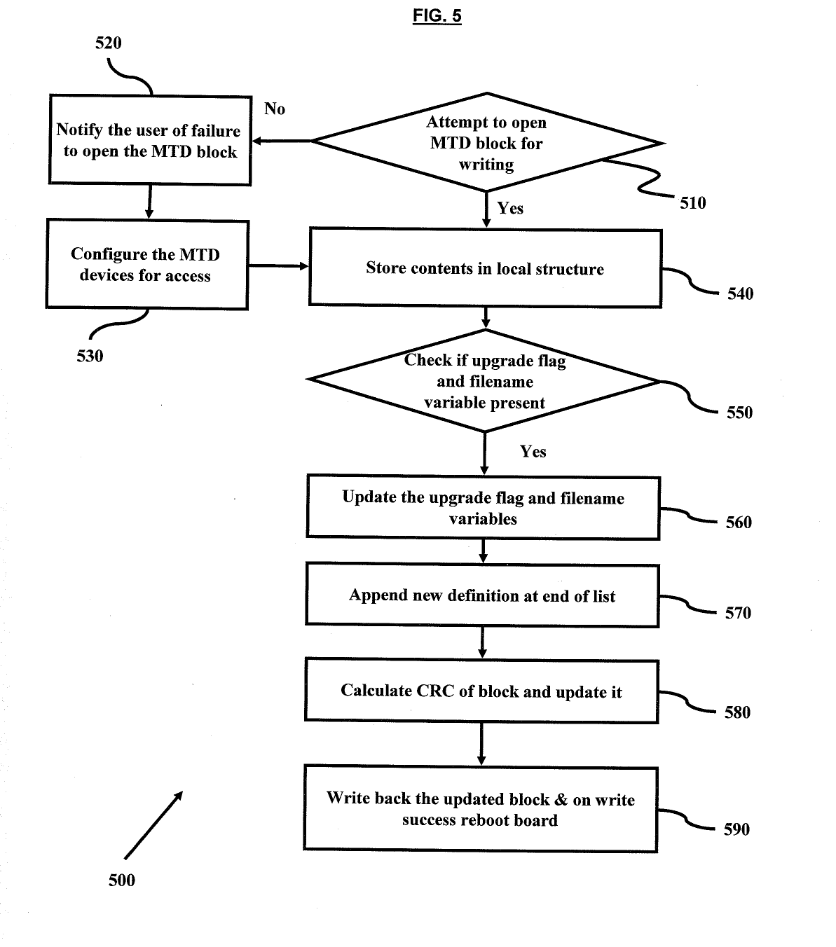

FIG. 5 illustrates a flowchart depicting a method 500 of writing upgrade flag information in the flash, according to embodiments disclosed herein. The embedded system checks (510) for firmware upgrade image in memory technology device (MTD) block 1. If the MTD block is not accessible, then a message is send (520) to the user that the embedded system is not able to open the MTD block. The user then configures (530) the MTD block for access. Once the MTD block is open, the contents are stored (540) in the local structure and the upgrade flag and the filename variable are checked (550). If the upgrade flag and the filename variable are found, the system updates (560) the variables, appends (570) a new definition at the end of the structure and calculates (580) the CRC of the block and update the block using the calculated CRC. Thereafter, the new single image is written (590) on the updated block in flash and on rebooting the embedded system checks if a firmware upgrade needs to be performed.

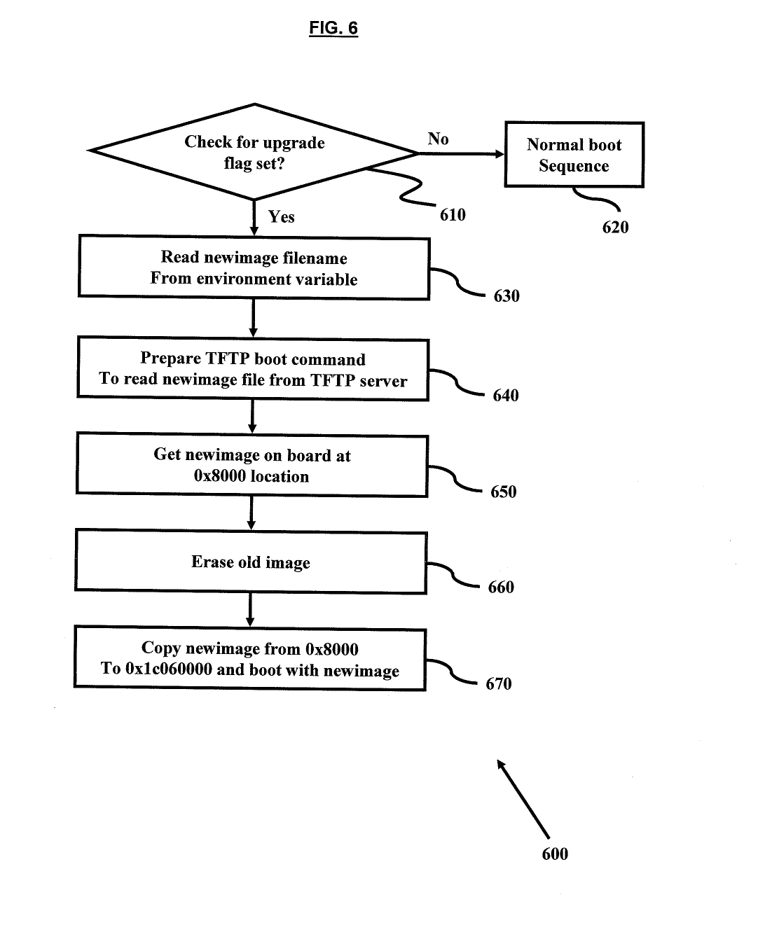

FIG. 6 illustrates a flowchart depicting a method 600 of upgrading the sequence from the modified boot loader, according to embodiments disclosed herein. At boot up time, the embedded system checks (610) whether the upgrade flag is set with the specified firmware upgrade file. If the upgrade flag is not set, the system boots (620) up normally with the available image. If the upgrade flag is set, the embedded system reads (630) the new image name from the environment variable section and issues (640) TFTP boot commands to read the new image from TFTP server and the new image is copied (650) at 0x8000 location. Further, the embedded system issues commands to erase (660) the old image and transfers (670) the new image from 0x8000 location to 0x1c60000 location and boots with the new updated firmware.

The embodiments disclosed herein provide a single step process from user/operator perspective which involves setting up upgrade flag from web console and providing image name while rest all activities are done automatically. The embodiments also provides a user friendly firmware upgrade, with very minimal effort from user/operator side, without knowledge of the command set and using a web console for complete firmware upgrade and reduces time compared to conventional firmware upgrade method, as all the commands are being executed internally. The embodiments disclosed also provides a easy approach to perform firmware upgrade for multiple boards as user/operator has to set up upgrade flags on respective embedded systems 120 using web console admin utility.

As can be appreciated, the embodiments disclosed herein allows performing firmware upgrades as simple and less time consuming solution while ensuring integrity of firmware and most importantly without any additional hardware or on-site human intervention. Also it is to be understood that the invention as described here is not limited to this precise embodiment and that various changes and modifications may be affected therein without departing from the original scope or spirit of present invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for automatic firmware upgrade on a target embedded system, where said target embedded system comprises of a volatile memory, and a non-volatile memory, and where said non-volatile memory comprises of a startup module, kernel configuration, an existing kernel image, and an existing file system image, and where said target embedded system is connected to a TFTP server and a web console, the method comprising:
generating single image from Linux kernel image and file system image;
providing said single image name as input to web console for firmware upgrade;
said web console writing upgrade flag and single image name information in said kernel configuration on said target embedded system;
said web console issuing a restart command to said target embedded system;
said startup module on said embedded system checking for upgrade flag;
startup module copying said single image from said TFTP server to a volatile memory of said target embedded system;
startup module erasing said existing kernel image and said existing file system image;
startup module copying said single image from said volatile memory to a pre-determined location on said non-volatile memory of said target embedded system;
said web console resetting said upgrade flag; and
startup module issuing command to boot using said single image.

2. The method of claim 1, when said startup module on said embedded system cannot find said single image on said TFTP server, the method further comprising:
said startup module trying to obtain said single image for a pre-determined number of maximum tries; and
when said single image is not found after said pre-determined number of maximum tries, said startup module continuing with normal boot up process.

3. The method of claim 1, where upgrade flag is set as an environment variable of kernel configuration in a protected memory location on said target embedded system.

4. The method of claim 1, where the step of writing upgrade flag information further comprises of performing of CRC calculation and storing said calculated CRC in a pre-determined location.

5. The method of claim 1, where the step of generating single image combining kernel image and file system image further comprising:
calculating offset based on kernel image file size; and
combining said flash file system image with said kernel image using said calculated offset.

6. The method of claim 1, where the upgrade includes applications.

7. The method of claim 1, where said embedded system uses one IVT.

8. A method for automatic firmware upgrade on a target embedded system, where said target embedded system comprises of a volatile memory, and a non-volatile memory, and where said non-volatile memory comprises of a startup module, kernel configuration, an existing kernel image, and an existing file system image, and where said target embedded system is connected to a TFTP server and a serial console, the method comprising:
generating single image from Linux kernel image and file system image;
storing said single image on said TFTP server;
writing upgrade flag and single image name information in said kernel configuration on said target embedded system;
issuing a restart command to said target embedded system;
startup module on said embedded system checking for upgrade flag;
startup module copying said single image from said TFTP server to a volatile memory of said target embedded system;
startup module erasing said existing kernel image and said existing file system image;
startup module copying said single image from said volatile memory to a pre-determined location on said non-volatile memory of said target embedded system;
resetting said upgrade flag;
startup module issuing command to boot using said single image.

9. The method of claim 8, when said startup module on said embedded system cannot find said single image on said TFTP server, the method further comprising:
said startup module trying to obtain said single image for a pre-determined number of maximum tries; and
when said single image is not found after said pre-determined number of maximum tries, said startup module continuing with normal boot up process.

10. The method of claim 8, where said upgrade flag is set as an environment variable of kernel configuration in a protected memory location on said target embedded system.

11. The method of claim 8, where the step of writing upgrade flag information further comprises of performing of CRC calculation and storing said calculated CRC in a pre-determined location.

12. The method of claim 8, where resetting of said upgrade flag is done by a user, said user using a web-console utility.

13. The method of claim 8, where the step of generating single image combining kernel image and file system image further comprising:
calculating offset based on kernel image file size; and
combining said flash file system image with said kernel image using said calculated offset.

14. The method of claim 8, where the upgrade includes applications.

15. The method of claim 8, where said embedded system uses one IVT.

16. A method of combining kernel image and file system image to form a single image, the method comprising:
calculating offset based on kernel image file size;
combining flash file system image with kernel image using said calculated offset.

17. The method of claim 16, where offset calculation is done by an external utility.
